(19) United States
(12) Patent Application Publication
(10) Pub. No.: US 2018/0353885 A1
(43) Pub. Date: Dec. 13, 2018

(54) FILTER FOR SULFUR COMPOUNDS

(71) Applicant: MSA TECHNOLOGY, LLC, CRANBERRY TOWNSHIP, PA (US)

(72) Inventors: Meghan E. Swanson, Pittsburgh, PA (US); Andrew Sassani, Elysburg, PA (US)

(21) Appl. No.: 15/995,775

(22) Filed: Jun. 1, 2018

Related U.S. Application Data
(60) Provisional application No. 62/517,939, filed on Jun. 11, 2017.

(51) Int. Cl. B01D 39/20; B01D 35/30; B01D 35/18; G01N 27/16

(52) U.S. Cl. CPC B01D 39/2003; B01D 39/2027; B01D 35/308; B01D 35/18; G01N 27/16; B01D 37/02; B01D 2239/0478; B01D 2239/10; B01D 2257/304; B01D 2257/55; B01D 2279/60; B01D 2239/0464

(57) ABSTRACT

A filter includes a filter media material through which a gas is transportable, a first metal salt immobilized upon the filter media material and a second metal salt immobilized upon the filter media material, wherein the first metal salt and the second metal salt are immobilized upon the filter media material from an aqueous solution comprising the first metal salt and the second metal salt.

### CROSS-REFERENCE TO RELATED APPLICATIONS

This application claims benefit of U.S. Provisional Patent Application Ser. No. 62/517,939, filed Jun. 11, 2017, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Sulfur compounds and especially hydrogen sulfide are emitted in conjunction with flammable gases. This is a challenge for catalytic combustible sensor designers since, for example, low-power palladium-based catalytic chemistries can be inhibited or deactivated by sulfur compounds. Catalytic inhibition in the field of combustible gas sensors is a safety concern since resulting gas concentration readings may be lower than those present in the environment. Many sensor designers address the problem of H₂S reaction and subsequent inhibition of the sensor pelement by using chemical filtration upstream of the active pelements to selectively remove H₂S from the analyte gas.

In general industry, removal of hydrogen sulfide is commonly accomplished at or near ambient temperature with a variety of methods, including contact with solutions such as liquid alkanolamine, ammonia, and alkaline salt. Gas-phase adsorption onto activated carbon or metal oxides such as iron is common for non-wetted applications, such as air purifying respirators for personal protection. In the case of chemical sensor filtration, with lower mass removal requirements, lower available volume, and higher efficiency specifications compared to other general industry applications, higher cost materials such as silver or copper may be considered. Silver compounds have been used as sulfur getters in electrochemical sensors for chlorine dioxide, ethylene oxide, and carbon monoxide. Copper has been used in combustible sensors in the form of a metal sinter or as a salt supported on high surface area adsorbent. The compounds can be formed into filters from a variety of powders, inks, and other non-water soluble processes. For example, ammonical solutions are necessary for processing “Whetlerite” type activated carbons for effective filtration of H₂S. Impregnated sorbents such as activated carbon or silica, when used for combustible sensor filtration, can effectively filter H₂S but can also impede passage of higher molecular weight combustible gases to the sensor head.

A number of currently available combustible gas sensor H₂S filters use lead acetate, which, in the presence of trace moisture, reacts with H₂S to form lead sulfide, and which does not significantly react with combustible gases or vapors. The filter can be produced by wetting glass filter media with a near-saturated aqueous solution of lead acetate at room temperature, then allowing the filter to dry. The filter-to-filter deposited mass is repeatable since the impregnation is at room temperature and is a relatively fast process with slow evaporation, which allows the lead acetate concentration to remain relatively constant throughout the procedure. Moreover, the water-based chemistry avoids use of corrosive or flammable solvents and the related specialized equipment and procedures required for such solvents. The use of glass media as a chemical filter substrate results in faster response to a variety of combustible gases, compared to slower response for longer chain hydrocarbons when adsorbent substrates are used. Glass media available from Whatman, such as type EPM2000, has been used for this application.

However, a worldwide recognition of the hazards of lead in electronic waste resulted in planned phase-out of the chemical as, for example, detailed in the Restriction of Hazardous Substances RoHS regulations, also known as Directive 2002/95/EC, which originated in the European Union and restricts the use of six hazardous materials found in electrical and electronic products, the disclosure of which is incorporated herein by reference. To comply with such regulations and/or standards, one or more effective alternatives to lead acetate chemical sensor filters must be found.

### SUMMARY

In one aspect, a filter includes a filter media material through which a gas is transportable, a first metal salt immobilized upon the filter media material and a second metal salt immobilized upon the filter media material, wherein the first metal salt and the second metal salt are immobilized upon the filter media material from an aqueous solution comprising the first metal salt and the second metal salt. The filter media material may, for example, include or be glass or quartz.

The first metal salt may, for example, be a copper salt. The first metal salt may, for example, be a zinc salt. In a number of embodiments, the first metal salt is a copper salt and the second metal salt is a zinc salt. In a number of embodiments, the copper salt is selected from the group consisting of cupric sulfate and cupric acetate, and the zinc salt is selected from the group consisting of zinc sulfate and zinc acetate.

The filter media may, for example, include substantially no or no lead. In a number of embodiments, the filter media may include a suitably low amount of lead or no lead such that it is in compliance with standards such as the RoHS standards.

In another aspect, a gas sensor, includes a housing, an inlet in the housing, at least one sensing element in fluid connection with the inlet and a filter positioned between the inlet and the sensing element. The filter includes a filter media material through which a gas is transportable, a first metal salt immobilized upon the filter media material and a second metal salt immobilized upon the filter media material, wherein the first metal salt and the second metal salt are immobilized upon the filter media material from an aqueous solution comprising the first metal salt and the second metal salt. In a number of embodiments, the filter media material includes or is glass or quartz. The sensing element may, for example, be a combustible gas sensor sensing element including a catalyst immobilized upon a support and a heating element to heat the catalyst immobilized upon the support.

As described above, the first metal salt may, for example, be a copper salt. Alternatively, the first metal salt may, for example, be a zinc salt. In a number of embodiments, the first metal salt is a copper salt and the second metal salt is a zinc salt. The copper salt may, for example, be selected from the group consisting of cupric sulfate and cupric acetate, and the zinc salt may, for example, be selected from the group consisting of zinc sulfate and zinc acetate.

Once again, the filter media of the filter may, for example, include substantially no or no lead. In general, the filter media may include a suitably low amount of lead or no lead such that it is in compliance with standards such as the RoHS standards.

The gas sensor may, for example, further include a filter to remove silicone compounds positioned between the inlet and the sensing element. The filter to remove silicone compounds may, for example, include silicon dioxide. The filter to remove silicone compounds may, for example, further include a material immobilized thereon to remove sulfur compounds. In a number of embodiments, the material to remove sulfur compounds immobilized on the filter to remove silicone compounds includes at least one of a copper salt or a zinc salt. In a number of embodiments, the material to remove sulfur compounds immobilized on the filter to remove silicone compounds includes a copper sulfate.

In a further embodiment, a method of forming a filter for removing sulfur compounds includes forming an aqueous solution comprising two or more metal salts such as a copper salt and a zinc salt, immersing a filter media material through which a gas is transportable in the aqueous solution, removing the filter media material from the aqueous solution, and drying the filter media material, whereby the two or more metal salts (for example, (a copper salt and a zinc salt) are immobilized upon the filter media material. The method may, for example, further include, after drying the filter media material, immersing the filter media material in the aqueous solution at least a second time, removing the filter media material from the aqueous solution, and drying the filter media material.

In a number of embodiments, the filter media material includes glass or quartz. In a number of embodiments, the first metal salt is a copper salt and the second metal salt is a zinc salt. The copper salt may, for example, be selected from the group consisting of cupric sulfate and cupric acetate, and the zinc salt may, for example be selected from the group consisting of zinc sulfate and zinc acetate.

The present devices, systems, methods and compositions, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates the response of combustible sensors made with a glass filter impregnated with metal salts as set forth in the legend.

FIG. 2A illustrates schematically a portion of a combustible gas sensor including a filter hereof for removal of sulfur compounds and a filter for removing higher molecular weight compounds.

FIG. 2B illustrates an enlarged view of the sensing element of the combustible gas sensor of FIG. 2A.

FIG. 2C illustrates a Wheatstone bridge circuit for the combustible gas sensor of FIG. 2A.

FIG. 2D illustrates a perspective exploded or disassembled view of a combustible gas sensor hereof including the filters of FIG. 2A.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a filter element” includes a plurality of such filter elements and equivalents thereof known to those skilled in the art, and so forth, and reference to “the filter element” is a reference to one or more such filter elements and equivalents thereof known to those skilled in the art, and so forth. Likewise, a reference to “a metal salt” includes a plurality of such metal salts and a reference to “the metal salt” is a reference to one or more such metal salts and equivalents thereof as known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

In a number of embodiments, filters or filter elements hereof provide similar or better H₂S tolerance than filters based upon lead acetate chemistry and may be deployed in a similar room temperature, aqueous process. In a number of embodiments, a solution of two or more water soluble metal salts in aqueous solution is applied to a filter media. As used herein, a filter media, refers to a material suitable to immobilize the metal salts hereof and through which gas (for example, including a gas analyte) is transportable. In the case of a combustible gas sensor, the filter media hereof may, for example, be suitable for use in the vicinity of a sensing element operated at high temperature. Suitable filter media materials for use in combustible gas sensors include, but are not limited to, glass and quartz. For uses at lower temperature, other materials such as filter media paper may be used. The solution of two or more metal salts serves a number of purposes. Initially, the solution of two or more salts allows increased total solubility compared to a single salt solution. Further, the combination of metals has been found to enhance sulfur compound removal as compared to the individual metals. Without limitation to any mechanism, the immobilized metal mixture or combination may, for example, be operable to induce a solid state ion diffusion to occur during the reaction with a sulfur compound such as H₂S, which results in increased sulfur capacity compared to the sum of the separate components.

In a number of representative embodiments, a solution of two or more metal salts hereof includes a water soluble copper salt and/or a water soluble zinc salt. In a number of representative studies, an aqueous solution of cupric sulfate pentahydrate and zinc acetate dihydrate was applied to a filter medium material such as glass.

In a number of representative embodiments, glass microfiber filters (formed from borosilicate glass) without binders available from GE Healthcare Live Sciences of Marlborough, Mass. were studied (for example, EPM2000, GF/A, GF/B and GF/D glass microfiber filters). EPM2000 filters were chosen for further study because such filters retained a greater amount of metal salts during aqueous impregnation, compared to the GF/A filters. Sensors made with the GF/B and GF/D achieved high salt loadings, but exhibited lower methane sensitivity as compared to the EPM2000 filters. The EPM2000 filter (a glass microfiber filter sheet) had a thickness of 0.46 mm and a pore size of 2.0 μm. The GF/B and GF/D filters had thicknesses of 0.68 and 0.67 mm and pore sizes of 1.0 and 2.7 μm, respectively.

In a number of embodiments hereof, the filter media material of the filters hereof is glass or other media with air flow rate in the range or approximately 2-12 s/100 mL/in², basis weight is in the range of approximately 50-130 g/m², and thickness is in the range of approximately 0.25-0.70 mm. In a number of embodiments, the air flow rate is in the range or approximately 4-7 s/100 mL/in², basis weight is in the range of approximately 75-95 g/m², and thickness is in the range of approximately 0.35-0.55 mm.

In a number of embodiments, generally any water soluble salts of copper and zinc may be used in the representative precursor aqueous solutions hereof. Representative salts studied included cupric sulfate, cupric acetate, zinc sulfate and zinc acetate. In a number of studies, ratios of mass for the two salts of the precursor aqueous solution were determined by maximizing the solubility of one compound and adding the other compound in a maximum amount that would prevent cross-precipitation. In the case of the mass ratios of CuSO₄:ZnAc, the resulting ratios were 50:11 and 10:43. All intermediate ratios would also produce effective sulfur filters.

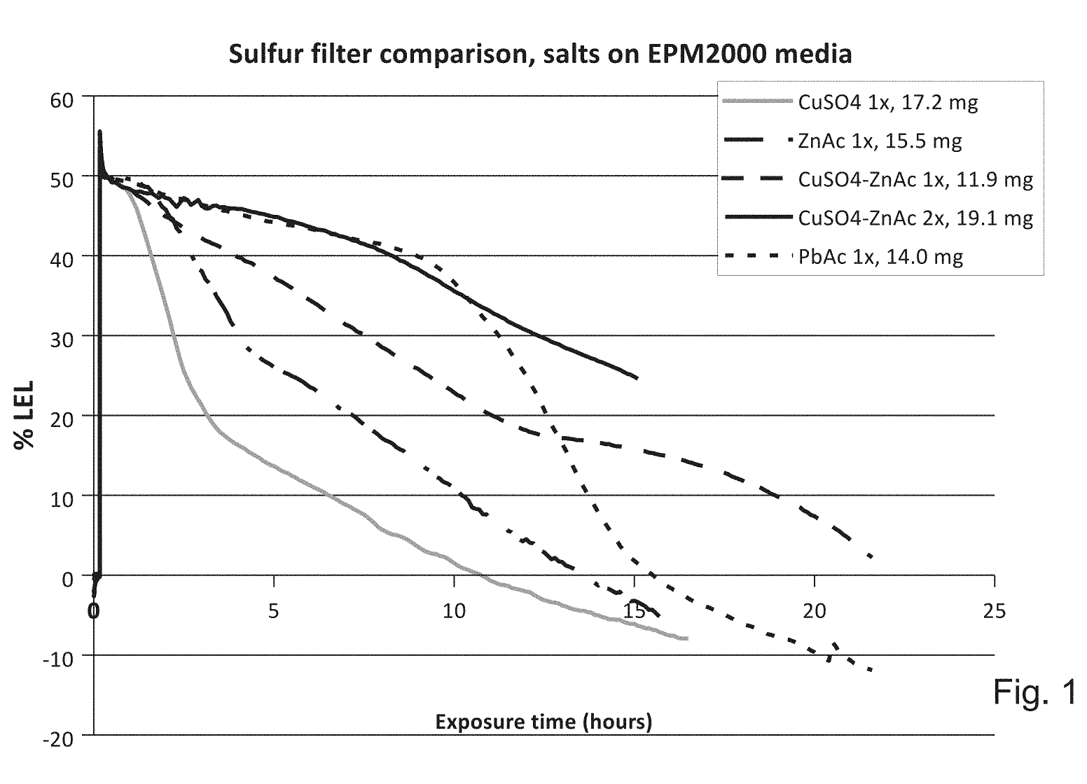

In the case of cupric sulfate and zinc acetate, the maximum solubility for cupric sulfate pentahydrate at 25° C. is 40.0 g per 100 mL water. It was determined that an additional 8.8 g zinc acetate dihydrate could be added to the solution without precipitation. Therefore the total metal salt loading of the solution was increased by 26% as compared to the single salt. High metal loadings were obtained as demonstrated in the data of Table 1, especially when the filter medium (glass filter) was impregnated once, dried, then impregnated and dried a second time. However, sulfur tolerance showed only a weak correlation with metal loading. Once again, and without limitation to any mechanism, enhanced sulfur tolerance of the combined salts, besides higher mass loading, may be explained by a solid-solid interaction between the sulfidation products copper sulfide and zinc sulfide resulted in improved H₂S capacity. This solid-solid sulfide interaction could explain the sulfur capacity enhancement shown in FIG. 1 for the combined salt filters compared to cupric sulfate or zinc acetate filters made from a single salt.

Table 1 and FIG. 1 show the results of sensor testing using glass filters impregnated with various metal salts using saturated aqueous solutions. The cupric sulfate-zinc acetate solution is 40.0 g of the former and 8.8 g of the latter per 100 mL deionized water as described above.

TABLE 1

| | | | H₂S capacity |
|---|---|---|---|
| | | Mass | atop EChem |
| | | loading | sensor |
| Salt | Chemical formula | (mg) | (a.u.) |
| Vanadyl sulfate | VOSO₄ | 27.0 ± 3.8 | 173 ± 67 |
| Manganese sulfate | MnSO₄ | 49.6 ± 5.1 | 187 ± 4 |
| Lead acetate | Pb(C₂H₃O₂)₂ | 13.8 ± 1.9 | 491 ± 96 |
| Cupric sulfate/zinc | CuSO₄/Zn(C₂H₃O₂)₂ | 23.0 ± 1.9 | 536 ± 4 |
| acetate | | | |

The results of Table 1 are shown as mean±standard deviation. Filters were tested in an experimental setup in which the filter hereof was affixed/positioned directly upstream of an electrochemical H₂S sensor. The test gas included 40 ppm H₂S in air. The H₂S capacity was calculated from the area under the curve of the scrubbed H₂S over the course of a 16 hour test. All filters were impregnated one time.

In a number of embodiments, sulfur compound filters hereof are used in connection with combustible gas sensors. Catalytic or combustible (flammable) gas sensors have been in use for many years to, for example, prevent accidents caused by the explosion of combustible or flammable gases. In general, combustible gas sensors operate by catalytic oxidation of combustible gases. The operation of a catalytic combustible gas sensor proceeds through electrical detection of the heat of reaction of a combustible gas on the oxidation catalyst, usually through a resistance change. The oxidation catalysts typically operate in a temperature above 300° C. to catalyze combustion of an analyte (for example, in the range of 350 to 600° C. temperature range for methane detection). Therefore, the sensor must sufficiently heat the sensing element through resistive heating. In a number of combustible gas sensors, the heating and detecting element are one and the same and composed of a platinum alloy because of its large temperature coefficient of resistance and associated large signal in target/analyte gas. The heating element may be a helical coil of fine wire as described above or a planar meander formed into a hotplate or other similar physical form. The catalyst being heated often is an active metal catalyst dispersed upon a refractory catalyst substrate or support structure. Usually, the active metal is one or more noble metals such as palladium, platinum, rhodium, silver, and the like and the support structure is a refractory metal oxide including, for example, one or more oxides of aluminum, zirconium, titanium, silicon, cerium, tin, lanthanum and the like. The support structure may or may not have high surface area (that is, greater than 75 m²/g). Precursors for the support structure and the catalytic metal may, for example, be adhered to the heating element in one step or separate steps using, for example, thick film or ceramic slurry techniques. A catalytic metal salt precursor may, for example, be heated to decompose it to the desired dispersed active metal, metal alloy, and/or metal oxide. A detailed discussion of pelements and catalytic combustible gas sensors which include such pelements is found in Mosely, P. T. and Tofield, B. C., ed., Solid State Gas Sensors, Adams Hilger Press, Bristol, England (1987). Combustible gas sensors are also discussed generally in Firth, J. G. et al., Combustion and Flame 21, 303 (1973) and in Cullis, C. F., and Firth, J. G., Eds., Detection and Measurement of Hazardous Gases, Heinemann, Exeter, 29 (1981).

FIG. 1 illustrates the response of combustible sensors made with one glass filter impregnated with metal salts as shown in the legend, one pressed pellet of 30 mg cupric-sulfate-impregnated silicon dioxide adsorbent, and a metal sinter between the active pelement or sensor element and the gas stream. The test gas consisted of 200 ppm H₂S, 2.5% vol methane, balance air. The ordinate shows the sensor signal in 2.5% vol methane (50% lower explosion limit or LEL) and provides a measure of sensor deactivation over time. The abscissa shows the time of the experiment in hours. Each five hours of run time at these conditions corresponds to a total dose of H₂S of 1000 ppm-h. The legend shows filters including cupric sulfate, zinc acetate, a single impregnation of cupric sulfate-zinc acetate solution, two impregnations of cupric sulfate-zinc acetate solution, and lead acetate, along with the respective mass loading after drying at room temperature.

As described above, the sulfur compound filters hereof may be used in conjunction with a second material (for example, an adsorbent material), which is included for the purpose of removing high molecular weight poisons from the analyte stream. One family of high molecular weight combustible sensor poisons is silicon-containing compounds. A representative effective adsorbent material is described in U.S. Pat. No. 6,756,016, the disclosure of which is incorporated herein by reference, which sets forth porous material having a surface area of no greater than approximately 200 m²/g. The surface area is limited to allow passage of heavy hydrocarbon analytes quickly through the filter. It is also possible to impregnate the porous material with a sulfur-gettering salt such as cupric sulfate, for additional sulfur tolerance. In other embodiments, one may minimize the volume devoted to the porous material by using higher surface area material. For example, Evonik Sipernat SIP50S silica, with a surface area of 500 m²/g, may be used to make a pellet with similar adsorption capacity as the material described in U.S. Pat. No. 6,756,016, but which takes up less than half the volume thereof. The available space in the sensor stackup/design might be used by one or more salt impregnated media filters (for example, salt impregnated glass) as described above. In a number of embodiments, two salt impregnated media filters hereof are used. Once again, the SIP50S silica of other adsorbent material for high-molecular weight poisons may also be impregnated with a sulfur gettering salt for additional sensor-level sulfur capacity.

For example, a copper salt (for example, cupric sulfate and/or cupric acetate) and/or a zinc salt (for example, zinc sulfate and/or zinc acetate) may be immobilized on SiO₂. The separate sulfur compound filters hereof (wherein a combination of metal salts is immobilized upon a material such as glass or quartz) provide additional sulfur compound capacity with the advantage of no sensitivity loss for hydrocarbons.

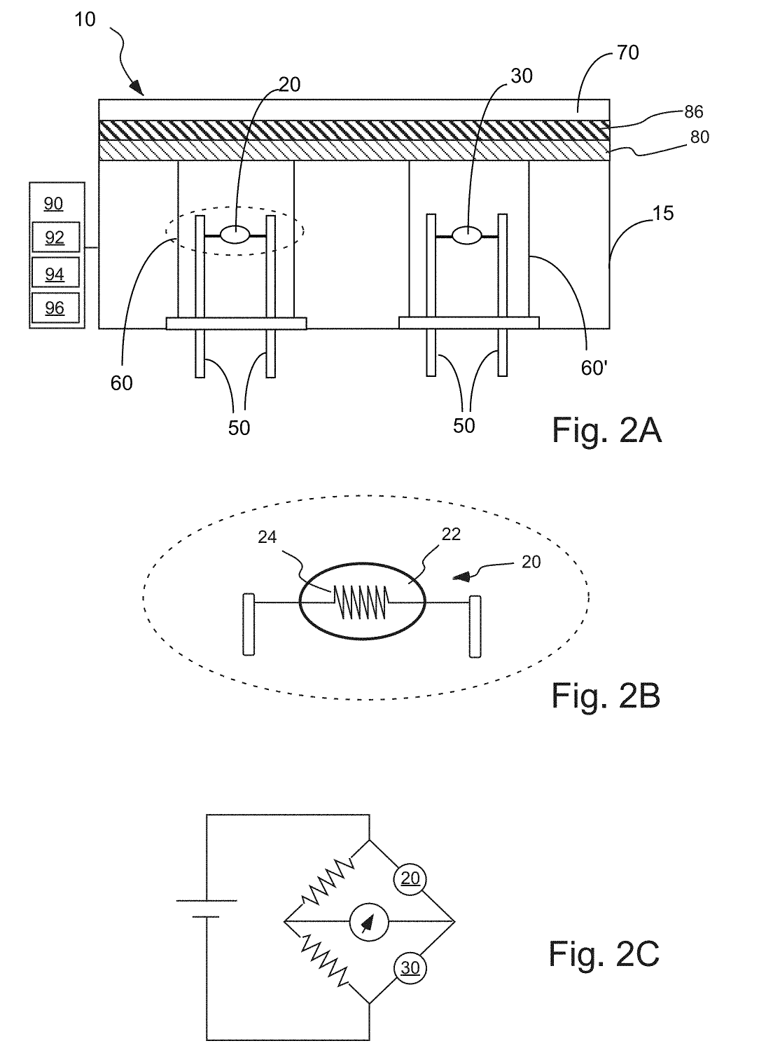

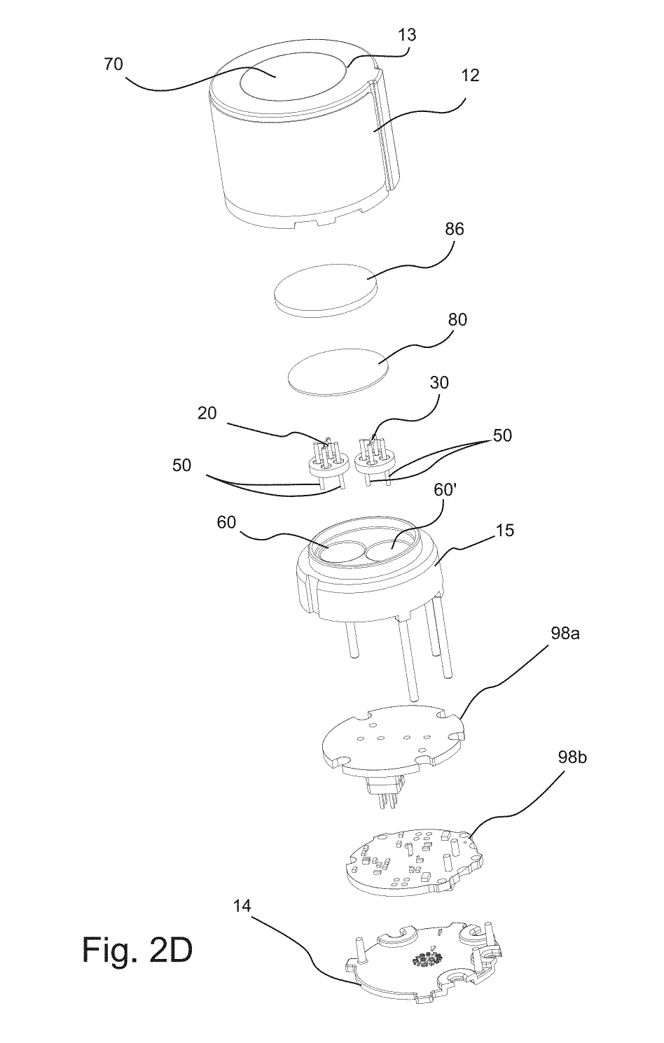

Referring to FIGS. 2A through 2D, one embodiment of a sensor 10 hereof is illustrated which includes a housing 12 comprising an inlet 13 via which gas from an environment surrounding sensor 10 enters housing 12. A base 14 may, for example, cooperate with housing 12 to enclose the components of sensor 10. An active element 20 and a compensating element 30 are positioned within chambers 60 and 60′, respectively, formed within a heat shield 15 of sensor 10. Active element 20 of sensor 10 may, for example, include a catalytic bead 22 encasing a platinum alloy wire 24, as best illustrated in FIG. 2B. Catalytic bead 22 may comprise, for example, a ceramic substrate with a palladium, platinum or other catalyst as known in the art. Active element 20 and compensating element 30 are in electrical connection with conducting posts 50 within cylindrical wells or chambers 60 and 60′ bored or molded into heat shield 15 (which may, for example, be formed from a plastic or a metal) as shown in FIG. 2A. Combustible gas sensor 10 also includes a flashback arrestor 70 such as a porous frit as known in the art.

Active element 20, and also a compensating element 30 (if present), may be separated from inlet 13 by a volume of a pressed, porous filter/filter material 86 that is large compared to the volume of each of active element 20 and compensating element 30. Filter 86 may, for example, be configured to remove (for example, via adsorption) relatively high molecular weight catalyst inhibitors or poisons such as silicone compounds (for example, hexamethyldisiloxane or HMDS). In the illustrated embodiment, sensor 10 further includes a sulfur compound filter 80 as described herein positioned between inlet 13 and active element 20/compensating element 30. A plurality of either such filters may be provided.

Active element 20 will react to phenomena other than catalytic oxidation that can change its output (i.e., anything that changes the energy balance on the bead) and thereby create errors in the measurement of combustible gas concentration. Among these phenomena are changes in ambient temperature, humidity, and pressure. To minimize the impact of such secondary effects on sensor output, the rate of oxidation of the combustible gas may, for example, be measured in terms of the variation in resistance of sensing element or pelement 20 relative to a reference resistance embodied in inactive, compensating element or pelement 30. The two resistances may, for example, be part of a measurement circuit such as a Wheatstone bridge circuit as illustrated in FIG. 2C. The output or the voltage developed across the bridge circuit when a combustible gas is present provides a measure of the concentration of the combustible gas. The characteristics of compensating pelement 30 are typically matched as closely as possible with active or sensing pelement 20. In a number of systems, compensating pelement 30 may, however, either carry no catalyst or carry an inactivated or poisoned catalyst. In general, changes in properties of compensating elements caused by changing ambient conditions are used to adjust or compensate for similar changes in the sensing element.

As known in the art, combustible gas sensor 10 may, for example, include circuitry 90, which may, for example, include measurement circuitry (as, for example, described in FIG. 2C), control circuitry, one or more processor systems 92 (for example, including one or more microprocessors) and an associated memory system 94 (on which control/measurement software may be saved) in communicative connection with processor(s) 92. A power source 96 may, for example, include one or more batteries in the case of a portable combustible gas sensor. Circuitry 90 may, for example, be positioned on one or more printed circuit boards 98a and 98b as illustrated in FIG. 2D.

The terms “electronic circuitry”, “circuitry”, “circuit,” or the like as used herein include, but are not limited to, hardware, firmware, software or combinations of each to perform a function(s) or an action(s). For example, based on a desired feature or need. a circuit may include a software controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software or combinations of each to perform a function(s) or an action(s), or to cause a function or action from another component. For example, based on a desired application or need, logic may include a software controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller,” as used herein includes, but is not limited to, any circuit or device that coordinates and controls the operation of one or more input or output devices. For example, a controller can include a device having one or more processors, microprocessors, or central processing units (CPUs) capable of being programmed to perform input or output functions.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

As described above, lead acetate impregnated glass filter media have been used as an effective filter for sulfur-containing compounds. However, the lead in such filter poses a potential environmental threat. The filters hereof are lead free and/or in compliance with standards such as the RoHS standards, while providing relatively high sulfur compound (for example, H₂S) tolerance. Moreover, the filters hereof are prepared using water-soluble, metal salt precursors. A combination of metal salt precursors such as zinc and copper precursors may be added in combination to increase total metal salt solubility, and thereby increase chemisorption sites for H₂S removal on the filter media. Use of water soluble precursors (particularly at room temperature), facilitates production of filters hereof. No special equipment is required to handle potentially hazardous solutions (for example, using solvents such as ammonia) or to continuously heat the process solution.

The filter devices, systems and methodologies hereof may be used in any situation in which it is desirable to remove sulfur compounds such as H₂S. As described in connection with the representative examples above, the filter devices, systems and methodologies hereof may be used in connection with gas sensors in which one or more sulfur compounds may be an interferent, an inhibitor or a poison to catalytically active sensing elements. The filters hereof have particular utility in combustible gas sensors. Such combustible gas sensor may be designed and/or operated in many different manners such as, for example, described herein, as well as in U.S. Pat. No. 8,826,721 and U.S. patent application Ser. Nos. 15/597,859 and 15/597,933, the disclosures of which are incorporated herein by reference.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A filter comprising a filter media material through which a gas is transportable, a first metal salt immobilized upon the filter media material and at least a second metal salt, different from the first metal salt, immobilized upon the filter media material, wherein the first metal salt and the at least a second metal salt are immobilized upon the filter media material from an aqueous solution comprising the first metal salt and the at least a second salt.

2. The filter of claim 1 wherein the first metal salt is a copper salt.

3. The filter of claim 1 wherein the first metal salt is a zinc salt.

4. The filter of claim 1 wherein the first metal salt is a copper salt and the at least a second metal salt is a zinc salt.

5. The filter of claim 5 wherein the filter media material comprises glass or quartz.

6. The filter of claim 5 wherein the copper salt is selected from the group consisting of cupric sulfate and cupric acetate and the zinc salt is selected from the group consisting of zinc sulfate and zinc acetate.

7. The filter of claim 1 wherein the filter media material includes no lead.

8. A gas sensor, comprising a housing, an inlet in the housing, at least one sensing element in fluid connection with the inlet and a filter positioned between the inlet and the at least one sensing element, the filter comprising a filter media material through which a gas is transportable, a first metal salt immobilized upon the filter media material and a at least a second metal salt immobilized upon the filter media material, wherein the first metal salt and the at least a second metal salt are immobilized upon the filter media material from an aqueous solution comprising the first metal salt and the at least a second metal salt.

9. The gas sensor of claim 8 wherein the first metal salt is a copper salt.

10. The gas sensor of claim 8 wherein the first metal salt is a zinc salt.

11. The gas sensor of claim 8 wherein the first metal salt is a copper salt and the at least one second metal salt is a zinc salt.

12. The gas sensor of claim 11 wherein the at least one sensing element is a combustible gas sensor sensing element comprising a catalyst immobilized upon a support and a heating element to heat the catalyst immobilized upon the support.

13. The gas sensor of claim 12 wherein the filter media material comprises glass or quartz.

14. The gas sensor of claim 12 wherein the copper salt is selected from the group consisting of cupric sulfate and cupric acetate and the zinc salt is selected from the group consisting of zinc sulfate and zinc acetate.

15. The gas sensor of claim 12 further comprising a filter to remove silicone compounds positioned between the inlet and the at least one sensing element.

16. The gas sensor of claim 15 wherein the filter to remove silicone compounds comprises silicon dioxide.

17. The gas sensor of claim 16 wherein the filter to remove silicone compounds further includes a material immobilized thereon to remove sulfur compounds.

18. The gas sensor of claim 17 wherein the material to remove sulfur compounds immobilized on the filter to remove silicone compounds comprises at least one of a copper salt or a zinc salt.

19. The gas sensor of claim 17 wherein the material to remove sulfur compounds immobilized on the filter to remove silicone compounds comprises a copper sulfate.

20. The gas sensor of claim 8 wherein the filter media material includes no lead.

21. A method of forming a filter for removing sulfur compounds comprising:
forming an aqueous solution comprising a first metal salt and a at least one second metal salt, immersing a filter media material through which a gas is transportable in the aqueous solution,
removing the filter media material from the aqueous solution, and
drying the filter media material, whereby the first metal salt and the at least one second metal salt are immobilized upon the filter media material.

22. The method of claim 21 wherein the first metal salt is a copper salt.

23. The method of claim 21 wherein the first metal salt is a zinc salt.

24. The method of claim 21 wherein the first metal salt is a copper salt and the at least one second metal salt is a zinc salt.

25. The method of claim 21 further comprising:
after drying the filter media material, immersing the filter media material in the aqueous solution at least a second time,
removing the filter media material from the aqueous solution, and
drying the filter media material.

26. The method of claim 21 wherein the filter media material comprises glass or quartz.

27. The method of claim 21 wherein the first metal salt is a copper salt is selected from the group consisting of cupric sulfate and cupric acetate and the second metal salt zinc salt is selected from the group consisting of zinc sulfate and zinc acetate.

28. The method of claim 21 wherein the filter media material includes no lead.
